(19) United States
(12) Patent Application Publication
(10) Pub. No.: US 2010/0186444 A1
(43) Pub. Date: Jul. 29, 2010

(54) Crystallizer With Internal Scraped Cooled Wall and Method of Use Thereof

(75) Inventors: J. A. Evers, Bilthoven (NL); Johannes van Spronsen, Noordwijk (NL); Elif Fatma Genceli Güner, Delft (NL); Marcos Rodriguez Pascual, Schiedam (NL); Geert-Jan Witkamp, Bergschenhoek (NL)

Correspondence Address: BANNER & WITCOFF, LTD., 28 STATE STREET, SUITE 1800, BOSTON, MA, 02109-1701, US

(73) Assignee: Technische Universiteit Delft, Delft (NL)

(21) Appl. No.: 12/563,199

(22) Filed: Sep. 21, 2009

Related U.S. Application Data
(63) Continuation of application No. PCT/EP2007/002463, filed on Mar. 20, 2007.

(51) Int. Cl. B01D 9/04; B01D 9/00

(52) U.S. Cl. 62/544; 62/123

(57) ABSTRACT

Apparatus for separating solids from a mixture or solution, comprising an outer wall provided with an inlet for the mixture or solution and provided with a first discharge for discharging an ice slurry and a second discharge for discharging a salt slurry, one or more raking or scraping elements for scraping solidified material from cooled wall portions which are cooled at or close to a temperature where the mixture or solution solidifies, preferably the eutectic temperature thereof.

### PRIORITY INFORMATION

This application is a continuation of PCT application no. PCT/EP2007/002463 designating the United States and filed Mar. 20, 2007 and is hereby incorporated herein by reference in its entirety for all purposes.

### FIELD OF THE INVENTION

The present invention relates to the field of crystallizers for liquids, e.g. containing an amount of solvable materials. Solids, viz. ice and salts, can be separated from the main solution by the difference in density and/or particle size. An apparatus for processing the recovery of crystallized material from aqueous solutions is known from EP 1230194.

### SUMMARY

Further crystallizers for removing crystals from a liquor is known e.g. from U.S. Pat. No. 5,102,544, U.S. Pat. No. 3,501,924, U.S. Pat. No. 3,283,522, and U.S. Pat. No. 3,344,616.

It is an object of the present invention to improve upon known crystallizers.

According to the present invention, an apparatus provides for separating solids from a mixture or solution, comprising an outer wall provided with an inlet for the mixture or solution and provided with a first discharge for discharging an ice slurry and a second discharge for discharging salt crystals, one or more raking or scraping elements for scraping solidified or crystallized material from cooled wall portions which are preferably cooled at or close to the eutectic temperature point, where salt and ice are separated at constant ratio, while maintaining thermodynamic equilibrium.

The apparatus according to the present invention provides for a more accurate operation thereof because of the relatively large scraped cooled surface, creating a relatively high heat transfer.

Because the scraped wall portions are preferably spaced from the outer wall, heat-loss is minimized, while the outer wall can have very low heat conductivity, e.g. double walled or otherwise.

Because of the features of the apparatus according to the present invention, the present invention also provides for a more accurate method, e.g. within 0.5° C. or preferably 0.1° C. of the eutectic temperature of the solution.

According to a further preferred embodiment of the present invention, the apparatus comprises a number of modular parts, which can be arranged on top of each other, and which each preferably comprise the cooled wall portions and lines for cooling fluid, as well as a shaft with scrapers, which can be connected to a shaft attending from the electric motor in the top part.

In a preferred embodiment of the present invention, the apparatus is provided with one, preferably two sets of annular rings. In an alternative embodiment, however, it could very well be equipped with any number of such sets of annular rings, whichever is the optimal number.

According to a preferred embodiment, the cooling fluid transported in and out from the cooling elements by a helical line. It will, however, be conceivable for one skilled in the art that the cooling fluid can be transported in and out of the space defined by the cooling services without lines or tubes, while the inner space of the cooling element can also be equipped with guiding means for the cooling fluid.

The apparatus according to the present invention can be used for numerous applications, such as mineral salts, mineral acids, organic acids, amino acids, pharmaceutical drugs and other salts including MgSO₄, HNO₃ and CA(NO₃)₂.

Further details, features and advantages of the present invention will become clear when reading the following description, in which reference is made to the following figures, showing:

### BRIEF DESCRIPTION OF THE DRAWINGS

FIG. 1 a side view of a preferred embodiment of an apparatus according to the present invention;

FIG. 2 a sectional view of the embodiment shown in FIG. 1;

FIG. 3 a sectional view of the embodiment shown in FIGS. 1 and 2; and

FIG. 4 a more detailed sectional view of the embodiment shown in FIGS. 1, 2 and 3.

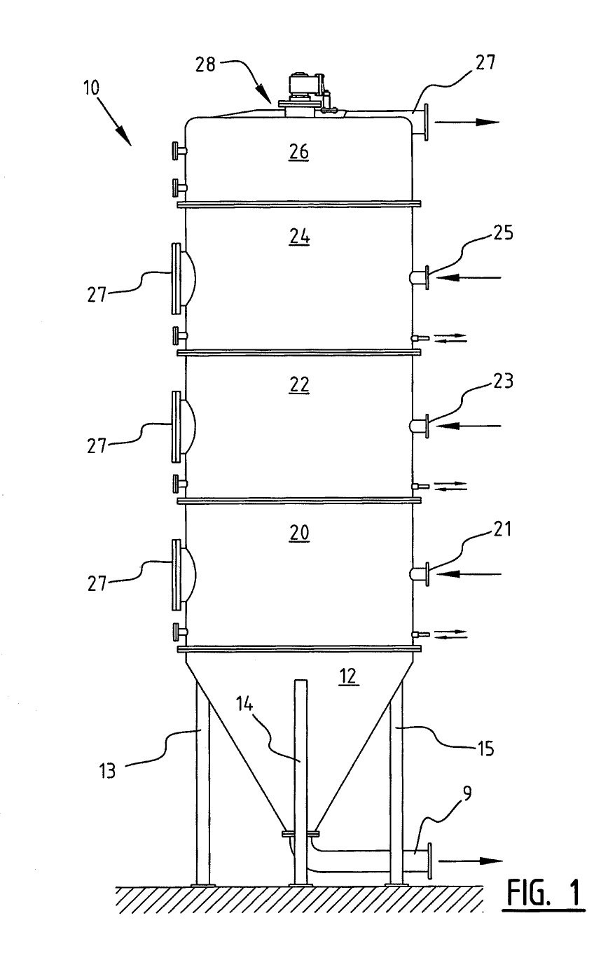

A preferred embodiment 10 of the apparatus according to the present invention (FIG. 1) comprises a lower hopper 12 which is supported by a steel construction comprising legs 13, 14 and 15, as well as intermediate modular parts 20, 22, 24 as well as a top part 26.

Each of the modules 20, 22, 24 is provided with an inlet 21, 23, 25 for introducing a mixture or solution into the interior of the modules, of which interiors are in open connection with the interiors of the modules below and above. Each of the intermediate modules is also provided with a manhole 27 for inspection and reparation thereof.

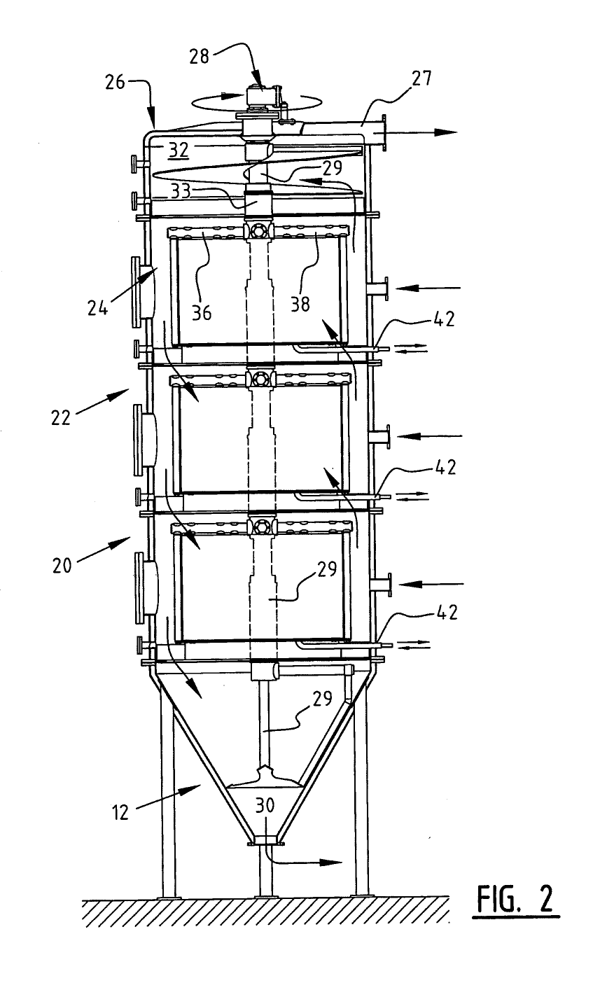

The top part 26 is provided with an discharge 27 for discharging ice crystals. The top part 26 includes a variable speed electric motor 28 (see also FIG. 2), driving a central shaft 29 extending through the module to a scraper 30 in the lower part 12. In the top part, the electric motor also drives a propeller 2 to press the ice crystal through the discharge 27. A clutch mechanism 33 is provided for driving the propeller 32.

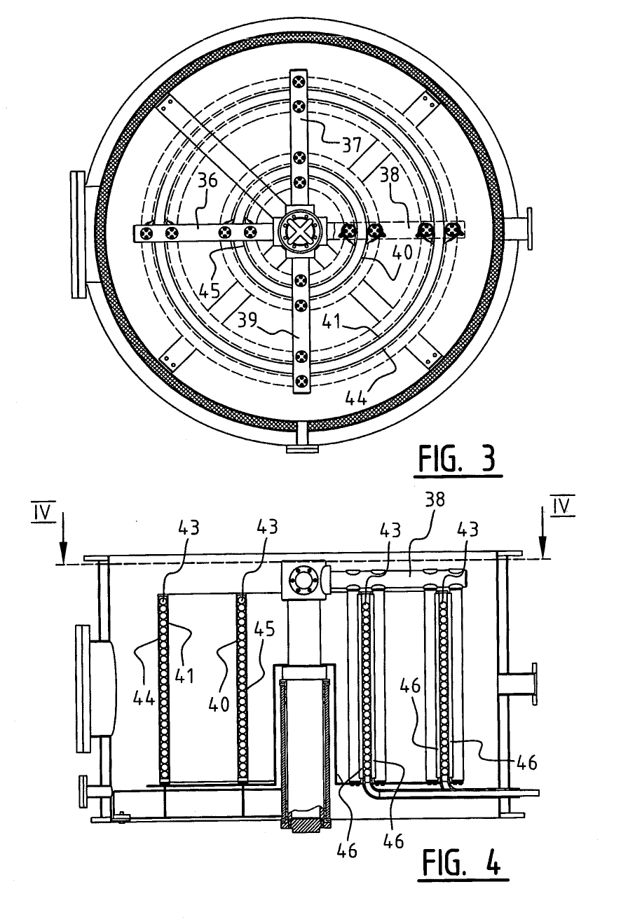

Also referring to FIGS. 3 and 4, each of the intermediate modules 20, 22, 24 is provided with arms 36, 37, 38, 39 coupled to the central shaft 29 for supporting scrapers 46 to scrape ice from two cylindrical walls 40, 45 and 41, 44. Each of the intermediate modules is provided with a connection 42 for cooling fluid for flowing in and out of helical line 43 which are provided in annular spaces between walls 40, 45 and 41, 44. When the arms 36-39 are rotated, the scrapers scrape along walls 40, 45 and 41, 44 to scrape of salt and/or ice crystals, so that the solidified water or ice moves upwardly and the concentrated salt crystals slurry is discharged through discharge 9.

The above described apparatus can easily be used for recover of crystallized material including MgSO₄ from aqueous solutions. Of course, it will also be possible to use it for salts, such as HNO₃ or Ca(NO₃)₂. The overall temperature of the solution can be e.g. within 2.0° C., preferably 0.5° C. or 0.1° C. of the eutectic point of such medium, e.g. around −12° C. for MgSO₄. The overall height of the apparatus can be a 1-10 metres.

The present invention is not limited to the above described preferred embodiment; the scope of the invention is to be defined by the annexed claims.

1. Apparatus for separating solids from a mixture or solution, comprising:
an outer wall provided with an inlet for the mixture or solution and provided with a first discharge for discharging an ice slurry and a second discharge for discharging a salt slurry;
one or more raking or scraping elements for scraping solidified material from cooled wall portions which are cooled at or close to a temperature where the mixture or solution solidifies, preferably the eutectic temperature thereof.

2. Apparatus according to claim 1, wherein the cooled wall portions are distanced from the outer wall.

3. Apparatus according to claim 1, wherein the cooled wall portions and/or the outer wall are cylindrical and coaxial.

4. Apparatus according to claim 1, wherein the cooled wall portions form annular rings.

5. Apparatus according to claim 1, wherein a second discharge is arranged in a lower hopper part of the apparatus.

6. Apparatus according to claim 1, comprising two or more modular parts which can be arranged on top of each other and which includes the outer wall, scraping elements and cooled wall portions.

7. Apparatus according to claim 1, provided with two annular spaces which are arranged concentrically, each annular space being provided with cooling fluid and in between which annular spaces the scraping elements are rotated to scrape the ice and/or salt from the cylindrical walls facing to each other.

8. Apparatus according to claim 1, provided with an electric motor for driving the scraping elements.

9. Apparatus according to claim 7, provided with a clutch provided between the electric motor and a shaft for driving the scraping elements.

10. A method for using an apparatus according to claim 1, wherein the cooled wall portions are kept within 2.0° C., preferably 0.5° C. or more preferably within a range of 0.1° C. of the eutectic freezing point.

11. A method according to claim 8, wherein the mixture comprises an aqueous solution including MgSO₄.
